(19) United States
(12) Patent Application Publication
(10) Pub. No.: US 2002/0190485 A1
(43) Pub. Date: Dec. 19, 2002

(54) Seal cap fitting structure

(75) Inventors: Masami Ohyama, Tokyo (JP); Takamitsu Tsuna, Tokyo (JP); Takahiro Tsuchiya, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: TDK CORPORATION, Tokyo (JP)

(21) Appl. No.: 10/173,417

(22) Filed: Jun. 18, 2002

(30) Foreign Application Priority Data
Jun. 19, 2001 (JP) 2001-184208

(51) Int. Cl. F16J 15/02

(52) U.S. Cl. 277/628

(57) ABSTRACT

A structure for fitting a seal cap for communicating an interior of a sealed case with an exterior according to the present invention includes a seal cap which incorporates a seal portion having a breathable porous film fixed to its one end fitted to avent tube of the sealed case, and a vent tube mounting part of the sealed case provided with projections, wherein the structure is so constructed that when the seal cap is fitted to the vent tube, an end of the seal cap comes into contact with the projections thereby to position the seal cap.

### BACKGROUND OF THE INVENTION

The present invention relates to a seal cap fitting structure, and more particularly to a structure for fitting a seal cap of a sealed container in which electronic components are hermetically sealed, and constructed so that a vent tube portion and a filter portion may not be easily broken.

Conventionally, there is a structure for preventing invasion of dust or the like into a sealed container without damaging air permeability between an interior and an exterior of the sealed container. The structure includes one end of a first tube portion having a linear portion fitted one end of a second tube portion having a bent portion, ,a breathable filter sandwiched at a fitting portion between them, and the other end of the first tube portion fitted to a connection portion in an opening of the sealed container.

Although the above described structure can prevent invasion of dust or water into the sealed container without damaging air permeability between the interior and the exterior of the sealed container, there has been such problems that because the vent tube includes the first tube portion projected from the sealed container and the second tube portion having the bent portion and fitted to the first tube portion, the long vent tube is projected from the sealed container, and accordingly, a wide mounting space has been required, and the vent tube has been likely-to be easily broken by an outer force such as contact with a hand of a person, for example.

### SUMMARY OF THE INVENTION

An object of the present invention is to provide a sealed container in which the above described drawbacks have been improved.

FIGS. 1A to 1E are views for explaining a structure according to the present invention. In FIGS. 1A to 1E, numeral 1 represents a sealed case, 1-1 represents an upper sealed case, 1-2 represents a lower sealed case, 2 represents a vent tube mounting part, 2-1 represents a surrounding wall thereof, 3 represents a vent tube, 4 represents a seal cap, 4-1 represents an end of the seal cap, 5 represents a seal portion, 5-1, 5-2 represent protrusions thereof, 6-1, 6-2, 6-3 represent projections, and 7 represents a breathable porous film.

The above described object of the present invention will be attained by the following structures (1) and (2).

(1) A structure for fitting a seal cap for communicating an interior of a sealed case 1 with an exterior characterized in that a seal cap 4 which incorporates a seal portion 5 having a breathable porous film 7 fixed to its one end is fitted to a vent tube 3 of the sealed case 1, and a vent tube mounting part 2 of the sealed case 1 is provided with projections 6-1, 6-2 and 6-3, and the structure is so constructed that when the seal cap 4 is fitted to the vent tube 3, an end 4-1 of the seal cap 4 comes into contact with the projections 6-1, 6-2 and 6-3. thereby to position the seal cap 4.

(2) A structure for fitting a seal cap as described in the above item (1), characterized in that the vent tube 3 is provided inside the vent tube mounting part 2 in a concave shape formed in the sealed case 1, and a distal end of the seal cap is positioned lower than a height of a surrounding wall 2-1 which constitutes the vent tube mounting part 2 in a concave shape, whereby a presence of the surrounding wall 2-1 makes it difficult to manually detach the seal cap 4, and also makes it difficult for the seal cap 4 to be accidentally pushed.

These structures will attain such operational effects as described below.

(1) When the seal cap is pushed down in a state that the seal portion having the breathable porous film fixed to its one end is covered on the vent tube, the end of the seal cap is engaged with the projections formed on the vent tube mounting part, and the seal cap will not further proceed. For this reason, the breathable porous film will be positioned so as not to be in contact with the vent tube, and accordingly, even though the seal cap is pushed down by force, the breathable porous film will not be broken by the vent tube.

(2) Because the structure is such that the vent tube is provided inside the vent tube mounting part in a concave shape, and the distal end of the seal cap is positioned lower than the height of the surrounding wall constituting the vent tube mounting part in a concave shape, the seal cap is located inside this narrow and low vent tube mounting part. As the results, since the seal cap can be arranged in a state where it can be hardly operated manually, the seal cap will be prevented from being detached by mistake or from being accidentally pushed, and safety can be enhanced.

### BRIEF DESCRIPTION OF THE DRAWINGS

FIGS. 1A to 1E are views for explaining a structure for fitting a seal cap according to the present invention; and

FIGS. 2A to 2D are views for explaining an essential part of the seal cap according to the present invention.

### DETAILED DESCRIPTION OF THE PREFERRED EMBODIMENT

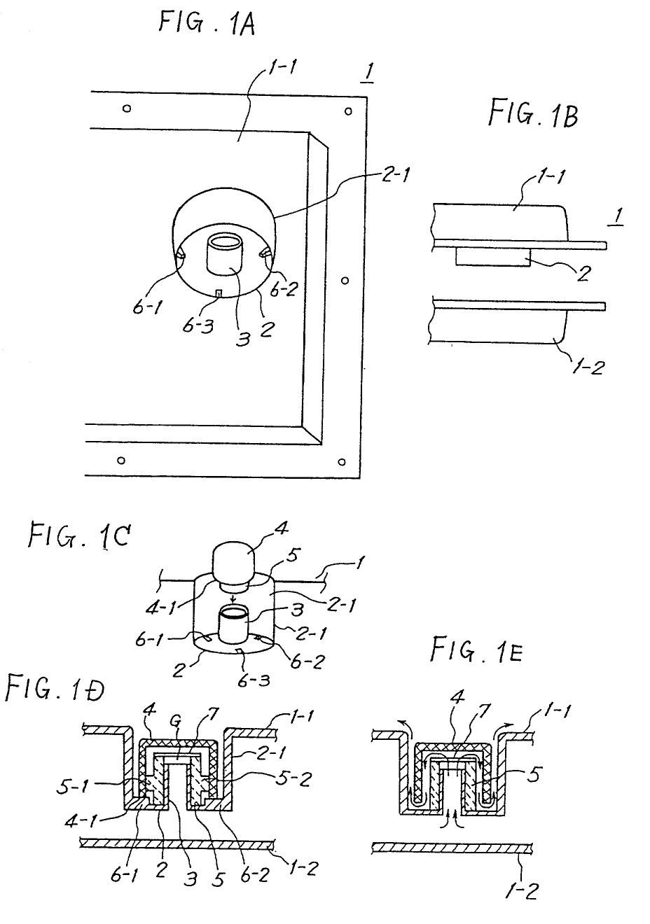

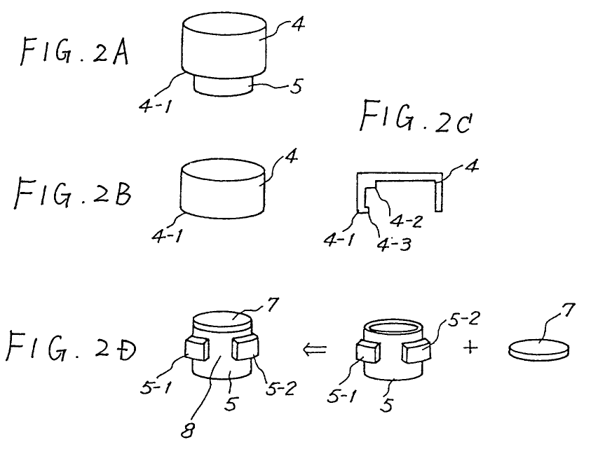

An embodiment of the present invention will be described referring to FIGS. 1A to 2D. FIGS. 1A to 1E are views for explaining a structure for fitting a seal cap according to the present invention, and FIGS. 2A to 2D are views for explaining an essential part of the seal cap according to the invention.

FIG. 1A is a perspective view of a part of the sealed container 1 illustrating the vent tube 3 provided inside the vent tube mounting part 2 provided in the upper sealed case 1-1 which constitutes the sealed case 1, projections 6-1, 6-2, 6-3 provided at positions of every 120 degree on a bottom part of this vent tube mounting part 2, and the surrounding wall 2-1 provided on the vent tube mounting part 2. FIG. 1B is an exploded view illustrating that the sealed case 1 includes the upper sealed case 1-1 and the lower sealed case 1-2, and that the bottom part of the vent tube mounting part 2 in a concave shape is projected from the upper sealed case 1-1 to be positioned inside the lower sealed case 1-2.

FIG. 1C shows a state just before the seal cap 4 which includes the seal portion 5 inserted therein is going to seal a distal end portion of the vent tube 3 which is projected from the bottom part of the vent tube mounting part 2, FIG. 1D shows a state in which the seal portion 5 and the seal cap 4 have sealed the distal end portion of the vent tube 3, and FIG. 1E shows a state in which the interior of the sealed case communicates with the exterior via the vent tube 3 and the breathable porous film 7.

FIGS. 2A to 2D are views for explaining steps in which the seal cap 4, the seal portion 5 and the breathable porous film 7 are fitted.

In FIGS. 1A to 1E, the sealed case 1 which contains therein, for example, an electric power converter to be mounted on a vehicle, and is made of light metal such as aluminum, includes the upper sealed case 1-1 and the lower sealed case 1-2 fixed to each other by means of screw bolts, for example.

The vent tube mounting part 2 in a cylindrical concave shape is provided in the upper sealed case 1-1, and the vent tube 3 in a hollow cylindrical shape is projected from the bottom part of the vent tube mounting part 2. On the bottom part of this vent tube mounting part 2, the projections 6-1, 6-2 and 6-3 are provided to come into contact with the end 4-1 of the seal cap 4 at positions of every 120 degree.

The seal cap 4, made of synthetic resin for example, includes the seal portion 5 disposed inside the seal cap 4 as shown in FIG. 2D, and serves to arrange the seal portion 5 at a predetermined position and protect it as will be described below. As shown in a sectional view in FIG. 2C, the seal cap 4 is further provided with three projections 4-2 (the other two are omitted) at positions of every 120 degree in an upper part inside thereof, and also provided with three projections 4-3 (the other two are omitted) at its end 4-1.

The seal portion 5 serves to maintain air flow between the interior and the exterior of the sealed case 1, and at the same time, to prevent dust or water from intruding into the sealed case. For this purpose, the breathable porous film 7 made of polytetrafluoroethylene is fixed to an opening at an end of the seal portion 5. The seal portion 5 which is formed of rubber, for example, in a cylindrical shape, is provided with three protrusions 5-1, 5-2 (5-3 is omitted in the drawings) in its outer peripheral area, and retained within the seal cap 4 by elasticity of the projections. When the seal portion 5 has been covered over the vent tube 3, a lower end of the seal portion 5 is positioned on the bottom part of the vent tube mounting part 2 as shown in FIGS. 1D and E. However, an upper end of the seal portion 5 is positioned apart from an upper end of the vent tube 3 by a gap G so that the breathable porous film 7 may not come into contact with a distal end of the vent tube 3.

When the seal cap 4 is covered over the distal end of the vent tube 3, the end 4-1 of the seal cap 4 is brought into contact with the projections 6-1, 6-2 and 6-3 formed on the bottom part of the vent tube mounting part 2 as shown in FIG. 1D, so that a clearance is formed between the inner face of the seal cap 4 and the breathable porous film 7 in this state. Although there are also provided the projections 4-2, 4-3 on the inner face of the seal cap 4, as shown in FIG. 2C, they are omitted in FIG. 1 for simplicity of illustration.

Now, the steps of fitting the seal cap 4 to the vent tube 3 will be explained.

As shown in FIG. 2D, the breathable porous film 7 is fixed to the opening at one end of the seal portion 5 by adhesive, for example, to be integral therewith. Then, the seal portion 5 integral with this breathable porous film 7 is inserted into the seal cap 4. On this occasion, the projections 4-3 formed inside the seal cap 4 as shown in FIG. 2C are guided through gaps 8 between the protrusions 5-1, 5-2 and 5-3 formed on the outer periphery of the seal portion 5. Then, the seal portion 5 is inserted into the seal cap 4 until the outer part at the distal end of the seal portion 5 has come into contact with the projections 4-2 of the seal cap 4. On this occasion, a part of the seal portion 5 is exposed outside of the seal cap 4 as shown in FIG. 2A, since the seal portion 5 is longer than an inner dimension of the seal cap 4.

After the seal cap 4 and the seal portion 5 have been integrally fixed to each other as shown in this FIG. 2A, this seal cap 4 is positioned above the vent tube 3 and moved in a direction of an arrow as shown in FIG. 1C. With this movement, the seal portion 5 is covered outside the vent tube 3 and moved so that the lower end of the seal portion 5 is located between the projections 6-1, 6-2 and 6-3 formed on the bottom part of the vent tube mounting part 2 and the vent tube 3, as shown in FIG. 1D. When the end 4-1 of the seal cap 4 has come into contact with these projections 6-1, 6-2 and 6-3 insertion of the seal cap 4 will be blocked, and a further downward movement of the seal cap 4 will be prevented. In this state, there exists the gap G between the distal end of the vent tube 3 and the breathable porous film 7.

After the seal cap 4 has been fitted to the vent tube 3 to seal the sealed case 1 in this manner, the interior of the sealed case 1 can communicate with the exterior via the breathable porous film 7 as shown by an arrow in FIG. 1E, while invasion of dust or water into the sealed case 1 from the exterior will be completely prevented.

In a state where the seal cap 4 has been fitted to the vent tube 3 as shown in FIG. 1D, even though the seal cap 4 is pushed down by force from the exterior, the seal cap 4 will be completely prevented from being pushed down, since the end 4-1 of the seal cap 4 is in contact with the projections 6-1, 6-2 and 6-3, and the vent tube 3 will not break the breathable porous film 7.

In the above description, there has been described a case in which the seal cap 4 and the seal portion 5 are fitted to the vent tube 3 after they have been integrally fixed to each other. However, the present invention is not limited to such a case, but after the seal portion 5 has been fitted to the vent tube 3, the seal cap 4 may be further fitted to the seal portion 5.

However, a width of the vent tube mounting part 2 in this embodiment has such a small size that a plurality of fingers cannot be easily inserted therein, and so, preferably, after the seal cap 4 and the seal portion 5 have been integrally fixed to each other, they may be fitted to the vent tube 3.

Moreover, because the seal cap 4 is positioned lower than a surface of the sealed case 1 as shown in FIGS. 1D and E, the seal cap 4 will not be pushed accidentally. However, because the seal cap 4 is located inside the surrounding wall constituting the vent tube mounting part, it has become difficult to detach the seal cap 4. Moreover, because the seal cap 4 is in tight contact with the protrusions 5-1, 5-2 and 5-3 of the seal portion 5, the seal cap 4 can be hardly detached the more.

According to the present invention, the following advantages can be attained.

(1) When the seal cap which has covered the seal portion having the breathable porous film fixed to its one end is pushed down, the end of the seal cap is engaged with the projections formed on the vent tube mounting part, and the seal cap will not further proceed. For this reason, the breathable porous film will be positioned so as not to be in contact with the vent tube, and accordingly, even though the seal cap is pushed down by force, the breathable porous film will not be broken by the vent tube.

(2) Because the structure is such that the vent tube is provided inside the vent tube mounting part in a concave shape, and the distal end of the seal cap is positioned lower than the height of the surrounding wall constituting the vent tube mounting part in a concave shape, the seal cap is located inside this narrow and low vent tube mounting part. As the results, since the seal cap can be arranged in a state where it can be hardly operated manually, the seal cap will be prevented from being detached by mistake or from being accidentally pushed, and safety can be enhanced.

What is claimed is:

1. A structure for fitting a seal cap for communicating an interior of a sealed case with an exterior comprising:
a seal cap including a seal portion having a breathable porous film fixed to one end of the seal portion fitted to the vent tube of a sealed case; and
at least one projection provided on a vent tube mounting portion of the sealed case,
wherein an end of the seal cap comes into contact with the projection to position the seal cap.

2. The structure as claimed in claim 1,
wherein the vent tube mounting portion of the sealed case has a concave shape, and
wherein a distal end of the seal cap is positioned lower than a height of a surrounding wall which constitutes the vent tube mounting portion in a concave shape.

3. The structure as claimed in claim 2, wherein the surrounding wall is located to prevent the seal cap from being manually detached and from being accidentally pushed.

4. The structure as claimed in claim 1, wherein the seal portion has at least one projection, and the seal cap covered on the seal portion is held by the projection.
